(19) United States
(12) Patent Application Publication
(10) Pub. No.: US 2024/0011749 A1
(43) Pub. Date: Jan. 11, 2024

(54) AMMUNITION CARTRIDGE CASES

(71) Applicant: Cesaroni Aerospace Incorporated, Bowling Green, FL (US)

(72) Inventor: Anthony Joseph Cesaroni, Sarasota, FL (US)

(73) Assignee: Cesaroni Aerospace Incorporated, Bowling Green, FL (US)

(21) Appl. No.: 18/034,599

(22) PCT Filed: Oct. 26, 2021
(86) PCT No.: PCT/US21/56576

§ 371 Date: Apr. 28, 2023

Related U.S. Application Data
(60) Provisional application No. 63/109,212, filed on Nov. 3, 2020.

(51) Int. Cl. F42B 5/307; F42B 5/285; B29C 67/24

(52) U.S. Cl. CPC F42B 5/307; F42B 5/285; B29C 67/246; B29K 2023/38

(57) ABSTRACT

An ammunition cartridge case comprising polycycloolefin derived from ring-opening metathesis polymerization (ROMP) reaction of a cyclic olefin. Methods, apparatus and systems for manufacturing the ammunition cartridge case.

### FIELD

The present disclosure relates to ammunition cartridge cases and the manufacture thereof.

### BACKGROUND

The potential for mass reduction and reduced manufacturing costs has not been fully realized due to many design trade-offs in existing ammunition cartridge cases. These are primarily related to pressure capability, manufacturing methods, and dimensional stability. For example, polymer ammunition cartridge cases have retained a metal cartridge base. Often, this portion of the cartridge is unsupported during firing and many traditional polymer compositions lack the mechanical properties to withstand chamber pressures. Because the base contains the highest percentage of metal, weight reduction is negligible when retaining a metal base.

Advances in polymer technology have produced materials that may overcome some of these problems but these can be difficult to convert to finished articles in practice due to processing limitations and/or cost. Typically, ammunition cartridge cases need to operate over a wide range of temperature ranges and be subject to a wide variety of environmental and chemical conditions. Engineered polymers such as Polyester Liquid Crystal Polymer and aromatic polyamides, such as High Temperature Nylon (HTN), may have the potential to meet these temperature and environmental requirements but strength at temperature extremes may limit their effectiveness.

Another challenge for polymer ammunition cartridge cases is the neck itself. Traditional methods used to seat the projectile into a polymer neck have been problematic primarily due to polymer mechanical properties such as tensile strength and creep. In order to circumvent this issue, insert injection molding of the projectile in situ is common. In practice, this reduces or eliminates projectile seating issues but precludes the use of conventional or existing seating and propellant loading equipment and propellant is loaded from the base of the cartridge as well.

There is a need for other materials, methods and systems for making ammunition cartridge cases.

The background herein is included solely to explain the context of the disclosure. This is not to be taken as an admission that any of the material referred to was published, known, or part of the common general knowledge as of the priority date.

### SUMMARY

In accordance with an aspect, there is provided an ammunition cartridge case comprising polycycloolefin derived from ring-opening metathesis polymerization (ROMP) reaction of a cyclic olefin.

With respect to aspects of the ammunition cartridge case disclosed herein, wherein the polycycloolefin derived from ROMP comprises linear polycycloolefin(s), branched polycycloolefin(s), crosslinked polycycloolefin(s), linear copolymers of cycloolefin(s), branched copolymers of cycloolefin(s), crosslinked copolymers of cycloolefin(s), or a combination thereof. In another aspect, wherein the polycycloolefin has high strength, toughness and chemical resistance over a temperature range from about −50° C. to about 180° C. In another aspect, wherein the polycycloolefin combines the chemical attributes of one or more of thermoplastics, thermosets and fluoropolymers. In another aspect, wherein the polycycloolefin has a glass transition temperature of from about 100° C. to about 200° C.; from about 110° C. to about 200° C., from about 120° C. to about 200° C., from about 130° C. to about 200° C., from about 140° C. to about 200° C., from about 150° C. to about 200° C., from about 160° C. to about 200° C., from about 170° C. to about 200° C., from about 180° C. to about 200° C., from about 100° C. to about 190° C., from about 100° C. to about 180° C., from about 110° C. to about 190° C., from about 110° C. to about 180° C., from about 120° C. to about 180° C., from about 130° C. to about 180° C., from about 140° C. to about 180° C., from about 145° C. to about 180° C., from about 150° C. to about 180° C., or from about 160° C. to about 180° C. In another aspect, wherein the polycycloolefin has a compressive strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa. In another aspect, wherein the polycycloolefin has a tensile strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa. In another aspect, wherein the cyclic olefin is Reaction Injection Molded (RIM) material. In another aspect, wherein the cyclic olefin has a viscosity ranging greater than about 0 cP to about 1000 cP at 25° C., from about 0.5 cP to about 1000 cP at about 25° C.; from about 0.5 cP to about 900 cP at about 25° C., from about 0.5 cP to about 800 cP at about 25° C., from about 0.5 cP to about 700 cP at about 25° C., from about 0.5 cP to about 600 cP at about 25° C., from about 0.5 cP to about 500 cP at about 25° C., from about 0.5 cP to about 400 cP at about 25° C., from about 0.5 cP to about 300 GP at about 25° C., from about 0.5 GP to about 200 cP at about 25° C., from about 0.5 cP to about 100 GP at about 25° C. from about 0.5 cP to about 50 cP at about 25° C.; from about 0.5 cP to about 25 cP at about 25° C., from about 0.5 cP to about 20 cP at about 25° C., from about 0.5 cP to about 10 cP at about 25° C., from about 0.5 cP to about 5 cP at about 25° C., from about 0.5 cP to about 3 cP at about 25° C., from about 0.5 cP to about 2 cP at about 25° C., from about 0.9 cP to about 1000 cP at about 25° C.; from about 0.9 cP to about 900 cP at about 25° C., from about 0.9 cP to about 800 cP at about 25° C. from about 0.9 cP to about 700 cP at about 25° C., from about 0.9 cP to about 600 cP at about 25° C., from about 0.9 cP to about 500 cP at about 25° C., from about 0,9 cP to about 400 GP at about 25° C., from about 0.9 cP to about 300 cP at about 25° C., from about 0.9 cP to about 200 cP at about 25° C., from about 0.9 cP to about 100 cP at about 25° C., from about 0.9 cP to about 50 cP at about 25° C., from about 0.9 cP to about 25 cP at about 25° C., from about 0.9 cP to about 20 cP at about 25° C., from about 0.9 cP to about 10 cP at about 25° C., from about 0.9 GP to about 5 cP at about 25° C., from about 0.9 cP to about 3 cP at about 25° C., from about 200 cP to about 300 cP at about 25° C., from about 900 cP to about 950 cP at about 25° C., less than about 35 cP at about 25° C., less than about 10 cP at about 25° C., or less than about 8 cP at about 25° C. In another aspect, wherein the cyclic olefin has a viscosity that is substantially the same as the viscosity of water at about 25° C. In another aspect, wherein the cyclic olefin comprises substituted or unsubstituted monocyclic olefin, substituted or unsubstituted polycyclic olefin, or a combination thereof, optionally including heteroatom(s) and/or functional group(s) thereof. In another aspect, wherein the cyclic olefin comprises substituted or unsubstituted strained monocyclic olefin, substituted or unsubstituted strained polycyclic olefin, substituted or unsubstituted unstrained monocyclic olefin, substituted or unsubstituted unstrained polycyclic olefin, or a combination thereof, optionally including heteroatom(s) and/or functional group(s) thereof. In another aspect, wherein the cyclic olefin comprises dicyclopentadiene (DCPD) resins, Lyondell™ 108, Lyondell™ 103, PROXIMA™ HPR 2029, PROXIMA™ HPR 2102, PROXIMA™ ACR 4100, PROXIMA™ HPR 2128, ethylidenenorbornene, methyltetracyclododecene, methylnorbornene, ethylnorbornene, dimethylnorbornene, norbornadiene, cyclopentene, cycloheptene, cyclooctene, 7-oxanorbornene, 7-oxanorbornene derivatives, 7-oxabicyclo[2.2.1]hept-5ene derivatives, 7-oxanorbornadiene, cyclododecene, 2-norbornene, also named bicyclo[2.2.1]-2-heptene and substituted bicyclic norbornenes, 5-methyl-2-norbornene, 5,6-dimethyl-2-norbornene, 5-ethyl-2-norbornene, 5-butyl-2-norbornene, 5-hexyl-2-norbornene, 5-octyl-2-norbornene, 5-dodecyl-2-norbornene, 5-isobutyl-2-norbornene, 5-octadecyl-2-norbornene, 5-isopropyl-2-norbornene, 5-phenyl-2-norbornene, 5-p-toluyl-2-norbornene, 5-a-naphthyl-2-norbornene, 5-cyclohexyl-2-norbornene, 5,5-dimethyl-2-norbornene, dicyclopentadiene (or cyclopentadiene dimer), dihydrodicyclopentadiene (or cyclopentene cyclopentadiene codimer), methyl-cyclopentadiene dimer, ethyl-cyclopentadiene dimer, tetracyclododecene, also named 1,2,3,4,4a,5,8,8a-octahydro-1,4:5,8-dimethyanonaphthalene, 9-methyl-tetracyclo[6.2.1.1^{3.6}0^{2,7}]-4-dodecene, also named 1,2,3,4,4a,5,8,8a-octahydro-2-methyl-4,4:5,8-dimethanonaphthalene, 9-ethyl-tetracyclo[6.2.1.1^{3.6}.0^{2,7}]-4-dodecene, 9-propyl-tetracyclo[6.2.1.1^{3.6}.0^{2,7}]-4-dodecene, 9-hexyl-tetracyclo[6.2.1.1^{3.6}.0^{2,7}]-4-dodecene, 9-decyl-tetracyclo[6.2.1.1^{3.6}.0^{2,7}]-4-dodecene, 9,10-dimethyl-tetracyclo[6.2.1^{3.6}.0^{2,7}]-4-dodecene, 9-ethyl, 10-methyl-tetracyclo[6.2.1.1^{3.6}.0^{2,7}]-4-dodecene, 9-cyclohexyl-tetracyclo[6.2.1.1^{3.6}.0^{2,7}]-4-dodecene, 9-chloro-tetracyclo[6.2.1.1^{3.6}.0^{2,7}]-4-dodecene, 9-bromo-tetracyclo[6.2.1.1^{3.6}.0^{2,7}]-4-dodecene, cyclopentadiene-trimer, methyl-cyclopentadiene-trimer, derivative(s) thereof, or a combination thereof, optionally including heteroatom(s) and/or functional group(s) thereof. In another aspect, wherein the cyclic olefin is selected from substituted or unsubstituted norbornene, substituted or unsubstituted norbornadiene, substituted or unsubstituted dicyclopentadiene, substituted or unsubstituted cyclobutene, substituted or unsubstituted cyclopentene, substituted or unsubstituted cycloheptene, substituted or unsubstituted cyclooctene, substituted or unsubstituted cyclononene, substituted or unsubstituted cyclodecene, substituted or unsubstituted cyclooctadiene, substituted or unsubstituted cyclononadiene, substituted or unsubstituted cyclododecene, substituted or unsubstituted 7-oxanorbornene, substituted or unsubstituted 7-oxanorbornadiene, derivative(s) therefrom, or a combination thereof, optionally including heteroatom(s) and/or functional group(s) thereof. In another aspect, wherein the cyclic olefin is selected from substituted or unsubstituted norbornene, substituted or unsubstituted dicyclopentadiene, a homolog thereof, a derivative thereof, or a combination thereof, optionally including heteroatom(s) and/or functional group(s) thereof. In another aspect, wherein the cyclic olefin comprises dicyclopentadiene (DCPD), such as endo-DCPD, and the polycycloolefin comprises poly-DCPD, wherein the poly-DCPD comprises non-crosslinked poly-DCPD and/or crosslinked poly-DCPD, optionally including functional group(s). In another aspect, further comprising a reinforcement material. In another aspect, wherein the reinforcement material adds further strength and/or further stiffness to the cartridge casing. In another aspect, wherein the reinforcement material is selected from woven and/or non-woven material. In another aspect, wherein the reinforcement material is selected from filament(s), fibre(s), roving(s), mat(s), weave(s), fabric(s), metal(s), metal alloy(s), composite(s), or a combination thereof. In another aspect, wherein the reinforcement material is selected from filament(s) and/or fibre(s). In another aspect, wherein the reinforcement material is selected from metal(s), metal alloy(s), carbon fibre(s), or a combination thereof.

In accordance with another aspect, there is provided a projectile comprising the cartridge case disclosed herein.

In accordance with another aspect, there is provided method for making a cartridge case as disclosed herein, the method comprising: heating the cyclic olefin and a metathesis catalyst, in a mold of the cartridge case, to a temperature whereby the cyclic olefin undergoes the ROMP reaction to form the polycycloolefin cartridge case.

In accordance with another aspect, there is provided method for making a cartridge case as disclosed herein, the method comprising: heating the cyclic olefin, in a mold of the cartridge case, to a temperature whereby the cyclic olefin will undergo the ROMP reaction to form the polycycloolefin once a metathesis catalyst is added; and adding the metathesis catalyst to the cyclic olefin to form the polycycloolefin cartridge case.

In accordance with another aspect, there is provided a method for making the cartridge case as disclosed herein, the method comprising: injecting a composition comprising the cyclic olefin and a metathesis catalyst into a mold of the cartridge case; and heating the composition, in the mold of the cartridge case, to a temperature whereby the cyclic olefin undergoes the ROMP reaction to form the polycycloolefin cartridge case.

With respect to aspects of the method for making the cartridge case as disclosed herein, wherein the method comprises reaction injection molding (RIM). In another aspect, wherein the heating comprises heating the mold. In another aspect, wherein the temperature is from about to about 500° C. or from about 25° C. to about 450° C. In another aspect, wherein a ratio of the catalyst to the cyclic olefin is from about 1:5 to about 1:100 (wt/wt), from about 1:10 to about 1:100 (wt/wt), from about 1;15 to about 1:100 (wt/wt), from about 1:20 to about 1:100 (wt/wt), from about 1:25 to about 1:100 (wt/wt), from about 1:30 to about 1:100 (wt/wt), from about 1:35 to about 1:100 (wt/wt), from about 1:40 to about 1:100 (wt/wt), from about 1:45 to about 1:100, from about 1:50 to about 1:100 (wt/wt), from about 1:55 to about 1:100 (wt/wt), from about 1:60 to about 1:100 (wt/wt), from about 1:70 to about 1:100 (wt/wt), from about 1:80 to about 1:100 (wt/wt), from about 1:10 to about 1:90 (wt/wt), from about 1:15 to about 1:80 (wt/wt), from about 1:20 to about 1:70 (wt/wt), from about 1:25 to about 1:65 (wt/wt), from about 1:30 to about 1:65 (wt/wt), from about 1:35 to about 1:65 (wt/wt), from about 1:40 to about 1:65 (wt/wt), from about 1:45 to about 1:60, from about 1:50 to about 1:60 (wt/wt), or from about 1:50 to about 1:55 (wt/wt). In another aspect, wherein the metathesis catalyst is a ruthenium and/or osmium metathesis catalyst. In another aspect, wherein the metathesis catalyst has a formula:

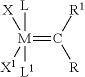

wherein: M is ruthenium or osmium; X and X¹ are each independently any anionic ligand; L and L¹ are each independently any neutral electron donor ligand; and, R and R¹ are each independently hydrogen or substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl, the substituent optionally substituted with one or moieties selected from the group consisting of C₁-C₁₀ alkyl, C₁-C₁₀ alkoxy, and aryl. In another aspect, wherein: M is ruthenium; R is hydrogen; R¹ is selected from the group consisting of C₁-C₁₀ alkyl, C₂-C₁₀ alkenyl, and aryl; X and X¹ are each independently selected from the group consisting of hydrogen, halide, C₁-C₂₀ alkyl, aryl, C₁-C₂₀ alkoxide, aryloxide, C₃-C₂₀ alkyldiketonate, aryldiketonate, C₁-C₂₀ carboxylate, arylsulfonate, C₁-C₂₀ alkylsulfonate, C₁-C₂₀ alkylthio, C₁-C₂₀ alkylsulfonyl, and C₁-C₂₀ alkylsulfinyl; and L and L¹ are each independently selected from the group consisting of phosphine, sulfonated phosphine, phosphite, phosphinite, phosphonite, arsine, stibine, ether, amine, amide, imine, sulfoxide, carboxyl, nitrosyl, pyridine, thioether and heterocyclic carbene. In another aspect, wherein: R 1 is selected from the group consisting of phenyl or vinyl, optionally substituted with one or more moieties selected from the group consisting of C₁-C₅ alkyl, C₁-C₅ alkoxy, and phenyl; X and X¹ are each a halide; and L and L¹ are each independently a phosphine of the formula PR³R⁴R⁵, where R³, R⁴, and R⁵ are each independently aryl or C₁-C₁₀ alkyl. In another aspect, wherein: R¹ substituent is phenyl or —C═C(CH₃)₂; X and X¹ are each chloride and L and L¹ are selected from a group consisting of -P(cyclohexyl)₃, -P(cyclopentyl)₃, -P(isopropyl)₃, and -P(phenyl)₃. In another aspect, wherein a preformed insert and/or base is placed in the mold prior to use.

In accordance with another aspect, there is provided a cartridge case made by the method disclosed herein.

In accordance with another aspect, there is provided a mold apparatus for making a cartridge case, the mold apparatus comprising: a mold having a mold chamber for forming a cartridge case; and an expandable core for insertion into the mold chamber.

With respect to aspects of the mold apparatus disclosed herein, wherein the expandable core comprises a mandrel and an expandable bladder. In another aspect, wherein the mandrel has a top portion and a bottom portion, the bottom portion is coupled to and surrounded by the expandable bladder. In another aspect, wherein the expandable bladder is capable of expanding via injection of a fluid into the top portion of the mandrel. In another aspect, wherein wherein the fluid comprises gas and/or liquid. In another aspect, wherein the expandable bladder comprises a plurality of segments and an activator pin. In another aspect, wherein the plurality of segments slidably shift outwards and engage to form an expanded state when the activator pin is inserted into the top portion of the mandrel.

In accordance with another aspect, there is provided the mold apparatus disclosed herein for making the cartridge case disclosed herein.

In accordance with another aspect, there is provided a use of the mold apparatus disclosed herein for making the cartridge case disclosed herein.

In accordance with another aspect, there is provided a cartridge case made by the mold apparatus disclosed herein. With respect to aspects of the cartridge case disclosed herein, wherein the cartridge case is as disclosed herein.

In accordance with another aspect, there is provided a system for making a cartridge case, the system comprising the mold apparatus disclosed herein.

With respect to aspects of the system disclosed herein, further comprising an injector having a reservoir for injection of a composition into the mold. In another aspect, further comprising a mix head for mixing the composition prior to injection into the mold. In another aspect, wherein the mold is at least one mold and the system further comprises at least one radial runner for conveying the composition to the at least one mold. In another aspect, further comprising a temperature controller for optimizing a temperature for polymerization of the composition within the mold. In another aspect, wherein the mold comprises at least two separate sections combined to form a mold chamber therebetween.

In accordance with another aspect, there is provided a method for making a cartridge case as disclosed herein using the system disclosed herein, the method comprising: inserting an expandable core into the mold chamber; injecting the cyclic olefin and a metathesis catalyst simultaneously or consecutively, into the mold chamber; expanding the bladder before, after or during injecting; heating the cyclic olefin and a metathesis catalyst to a temperature whereby the cyclic olefin undergoes the ROMP reaction to form the polycycloolefin cartridge case.

With respect to aspects of the method disclosed herein, wherein the mold is heated prior to injecting the cyclic olefin and a metathesis catalyst simultaneously or consecutively. In another aspect, wherein the mold is heated after injecting the cyclic olefin and a metathesis catalyst simultaneously or consecutively. In another aspect, wherein the bladder is expanded before injecting. In another aspect, wherein the bladder is expanded and the mold is heated before injecting. In another aspect, wherein the bladder is expanded once inserted into the mold chamber. In another aspect, wherein the expandable core is collapsed and the expandable core is removed from the mold chamber after the cartridge case has formed.

It is understood that one or more of the aspects described herein (and above) may be combined in any suitable manner. The novel features of the present disclosure will become apparent to those of skill in the art upon examination of the following detailed description. It should be understood, however, that the detailed description and the specific examples presented, while indicating certain aspects, are provided for illustration purposes only because various changes and modifications within the spirit and scope of the invention will become apparent to those of skill in the art from the detailed description and claims that follow.

### BRIEF DESCRIPTION OF THE DRAWINGS

The present disclosure will be further understood from the following description with reference to the Figures, in which:

FIG. 1A shows a perspective view of an exemplary molding apparatus for manufacturing a polymer ammunition cartridge case embodiment.

FIG. 1B shows an exemplary insert.

FIG. 2A shows a section of the perspective view of FIG. 1, showing an exemplary expandable core of the molding apparatus in its unexpanded state.

FIG. 2B shows a section of the perspective view of FIG. 1, showing the exemplary expandable core of FIG. 2A in its expanded state.

FIG. 3A shows a perspective view of an exemplary expanded silicone bladder of the expandable core.

FIG. 3B shows an end view of the expanded bladder of the expandable core of FIG. 3A.

FIG. 3C shows a perspective view of the expanded bladder as the activator pin is removed.

FIG. 3D shows an end view of the expanded bladder after the activator pin is removed.

FIG. 3E shows the silicone bladder collapsing after the activator pin is removed.

FIG. 3F shows the silicone bladder after it has collapsed.

FIG. 4A shows an alternative embodiment of the expandable core with an inflator device.

FIG. 4B shows a section of the expandable core of FIG. 4A along the A-A line.

FIG. 4C shows a close-up view of the internal components of the silicone bladder of the expandable core of FIG. 4A.

FIG. 4D shows a close-up view of the silicone bladder as it is being inflated.

FIG. 4E shows the silicone bladder in its fully inflated state.

FIG. 5A shows a sectional view of a single mold of an exemplary system for manufacturing polymer ammunition cartridge cases.

FIG. 5B shows a side view of the exemplary system of FIG. 5A.

FIG. 6 shows a top plan view of an exemplary system for multiple molds, where each mold is exemplified in FIG. 5A.

FIG. 7 shows an exemplary flow diagram showing steps for manufacturing polymer ammunition cartridge cases.

### DETAILED DESCRIPTION OF CERTAIN ASPECTS

### Definitions

Unless otherwise explained, all technical and scientific terms used herein have the same meaning as commonly understood by one of ordinary skill in the art to which this disclosure belongs. It is also to be understood that the terminology used herein is for the purpose of describing particular aspects only and is not intended to be limiting. Patent applications, patents, and publications are cited herein to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known additive, diluent, and the like. Typically, a composition consisting essentially of a set of components will comprise less than about 5% by weight, typically less than about 3% by weight, more typically less than about 1% by weight of non-specified components.

It will be understood that any component defined herein as being included may be explicitly excluded from the claimed invention by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

Although methods and materials similar or equivalent to those described herein can be used in the practice or testing of this disclosure, suitable methods and materials are described below.

Embodiments of ammunition cartridge cases, as well as systems and methods of manufacturing are described.

Typical ammunition includes the bullet (e.g. projectile), the cartridge case holding the bullet, a propellant and a primer, which ignites the propellant and provides the force to launch the bullet. The cartridge case can have several body shapes and head configurations, depending on the caliber of the ammunition. Common shapes of cartridge cases are as follows: a bottleneck cartridge case; a straight inner walled cartridge case, wherein the inner walls of the cartridge case are substantially parallel with a longitudinal axis of the case; and a tapered straight inner walled cartridge, wherein the inner walls are oblique or not parallel relative to the longitudinal axis of the case (examples are shown in U.S. Pat. No. 7,204,191).

In embodiments, the cartridge case comprises a polycycloolefin. The polycyclolefin may be derived from a ring-opening metathesis polymerization (“ROMP”) reaction. Cyclic olefins can be polymerized through ROMP reactions to provide the polycycloolefin. In embodiments, the polycycloolefin of the cyclic olefin produced through metathesis polymerization reactions can have high strength, toughness and/or have chemical resistance over a wide range of temperatures, including, for example, temperatures as low as cryogenic temperatures. Certain temperatures can vary, for example, over about −50° C. to about 180° C. In embodiments, the polycycloolefins combine the attributes of thermoplastics, thermosets and fluoropolymers. Such polycycloolefins are considered to be Reaction Injection Molded (RIM) material.

Suitable monomers include cyclic olefins that can be polymerized using metathesis polymerization catalysts. The cyclic olefins may be strained or unstrained, monocyclic or polycyclic, may optionally include heteroatoms, and may include one or more functional groups. One or more functional groups may be selected from hydroxyl, thiol, thioether, ketone, aldehyde, ester, ether, amine, imine, amide, nitro, carboxylic acid, disulfide, carbonate, isocyanate, carbodiimide, carboalkoxy, peroxy, anhydride, carbamate, and halogen. The cyclic olefins may include strained cyclic olefins or unstrained cyclic olefins, each of which may be functionalized or unfunctionalized. Embodiments herein contemplates preparation of homopolymers, as well as random and block copolymers and terpolymers of the suitable cyclic olefins. Suitable cyclic olefins include but are not limited to, substituted and unsubstituted, norbornene, norbornadiene, dicyclopentadiene, cyclobutene, cyclopentene, cycloheptene, cyclooctene, cyclononene, cyclodecene, cyclooctadiene, cyclononadiene, cyclododecene, 7-oxanorbornene, 7-oxanorbornadiene, and derivatives therefrom. Illustrative examples of suitable functional groups are listed above. Typical cyclic olefins include norbornene and dicyclopentadiene and their respective homologs and derivatives. In a typical embodiment, dicyclopentadiene (“DCPD”) is used and it has a low viscosity that is similar to water. Poly-dicyclopentadiene (Poly-DCPD) is made from a ROMP reaction from the monomer endo-dicyclopentadiene.

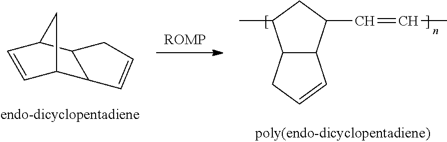

Poly-DCPD can then undergo vinyl polymerization to produce cross-linked Poly-DCPD.

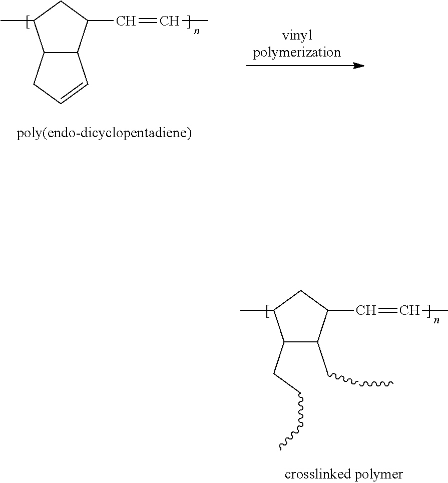

Poly-DCPD is highly cohesive during molding to itself and other materials, which permits multi-shot parts from the same mold cycle or secondary mold cycles possible.

Suitable dicyclopentadiene resins that may be used, for example, are Lyondell™ 108, Lyondell™ 103, PROXIMA™ HPR 2029, PROXIMA™ HPR 2102, PROXIMA™ ACR 4100, and PROXIMA™ HPR 2128. Other suitable cyclic olefins are described in U.S. Pat. Nos. 6,410,110, 4,943,621, 4,324,717 and 4,301,306, all of which are herein incorporated by reference, and include ethylidenenorbornene, methyltetracyclododecene, methylnorbornene, ethylnorbornene, dimethylnorbornene and similar derivatives, norbornadiene, cyclopentene, cycloheptene, cyclooctene, 7-oxanorbornene, 7-oxanorbornene derivatives, 7-oxabicyclo[2.2.1]hept-5ene derivatives, 7-oxanorbornadiene, cyclododecene, 2-norbornene, also named bicyclo[2.2.1]-2-heptene and substituted bicyclic norbornenes, 5-methyl-2-norbornene, 5,6-dimethyl-2-norbornene, 5-ethyl-2-norbornene, 5-butyl-2-norbornene, 5-hexyl-2-norbornene, 5-octyl-2-norbornene, 5-dodecyl-2-norbornene, 5-isobutyl-2-norbornene, 5-octadecyl-2-norbornene, 5-isopropyl-2-norbornene, 5-phenyl-2-norbornene, 5-p-toluyl-2-norbornene, 5-a-naphthyl-2-norbornene, 5-cyclohexyl-2-norbornene, 5,5-dimethyl-2-norbornene, dicyclopentadiene (or cyclopentadiene dimer), dihydrodicyclopentadiene (or cyclopentene cyclopentadiene codimer), methyl-cyclopentadiene dimer, ethyl-cyclopentadiene dimer, tetracyclododecene, also named 1,2,3,4,4a,5,8,8a-octahydro-1,4:5,8-dimethyanonaphthalene, 9-methyl-tetracyclo[6.2.1.1^{3,6}.0^{2,7}]-4-dodecene, also named 1,2,3,4,4a,5,8,8a-octahydro-2-methyl-4,4:5,8-dimethanonaphthalene, 9-ethyl-tetracyclo[6.2.1.1^{3,6}.0^{2,7}]-4-dodecene, 9-propyl-tetracyclo[6.2.1.1^{3,6}.0²⁷]-4-dodecene, 9-hexyl-tetracyclo[6.2.1.1^{3,6}.0^{2,7}]-4-dodecene, 9-decyl-tetracyclo[6.2.1.1^{3,6}.0^{2,7}]-4-dodecene, 9,10-dimethyl-tetracyclo[6.2.1.1^{3,6}.0^{2,7}]-4-dodecene, 9-ethyl, 10-methyl-tetracyclo[6.2.1.1^{3,6}.0^{2,7}]-4-dodecene, 9-cyclohexyl-tetracyclo[6.2.1.1^{3,6}.0^{2,7}]-4-dodecene, 9-chloro-tetracyclo[6.2.1.1^{3,6}.0^{2,7}]-4-dodecene, 9-bromo-tetracyclo[6.2.1.1^{3,6}.0^{2,7}]-4-dodecene, cyclopentadiene-trimer, methyl-cyclopentadiene-trimer, and the like.

The polycycloolefins derived from ROMP may be linear, branched and/or crosslinked polycycloolefins, linear, branched and/or crosslinked copolymer cycloolefins, or combinations thereof. The copolymer is understood to comprise two or more polymers.

In other embodiments, the cycloolefins have a low viscosity that is similar to water (about 0.9 cP at about 25° C.). In other embodiments, the viscosity of the cycloolefins can have a viscosity range greater than about 0 cP to about 1000cP at about 25° C., from about 0.5 cP to about 1000 cP at about 25° C.; from about 0.5 cP to about 900 cP at about 25° C., from about 0.5 cP to about 800 cP at about 25° C., from about 0.5 cP to about 700 cP at about 25° C., from about cP to about 600 cP at about 25° C., from about 0.5 cP to about 500 cP at about 25° C., from about 0.5 cP to about 400 cP at about 25° C., from about 0.5 cP to about 300 cP at about 25° C., from about 0.5 cP to about 200 cP at about 25° C., from about 0.5 cP to about 100 cP at about 25° C., from about 0.5 cP to about 50 cP at about 25° C., from about 0.5 cP to about 25 cP at about 25° C., from about 0.5 cP to about 20 cP at about 25° C., from about 0.5 cP to about 10 cP at about 25° C., from about 0.5 cP to about 5 cP at about 25° C., from about 0.5 cP to about 3 cP at about 25° C., from about 0.5 cP to about 2 cP at about 25° C., from about 0.9 cP to about 1000 cP at about 25° C.; from about 0.9 cP to about 900 cP at about 25° C., from about 0.9 cP to about 800 cP at about 25° C., from about 0.9 cP to about 700 cP at about 25° C., from about 0.9 cP to about 600 cP at about 25° C., from about 0.9 cP to about 500 cP at about 25° C., from about 0.9 cP to about 400 cP at about 25° C., from about 0.9 cP to about 300 cP at about 25° C., from about 0.9 cP to about 200 cP at about 25° C., from about 0.9 cP to about 100 cP at about 25° C., from about 0.9 cP to about 50 cP at about 25° C., from about 0.9 cP to about 25 cP at about 25° C., from about 0.9 cP to about 20 cP at about 25° C., from about 0.9 cP to about 10 cP at about 25° C., from about 0.9 cP to about 5 cP at about 25° C., from about 0.9 cP to about 3 cP at about 25° C. from about 200 cP to about 300 cP at about 25° C., or from about 900 cP to about 950 cP at about 25° C. The viscosity may be less than about 35 cP at about 25° C., less than about 10 cP at about 25° C., or less than about 8 cP at about 25° C.

In other embodiments, the polycycloolefins have a glass transition temperature of from about 100° C. to about 200° C.; from about 110° C. to about 200° C., from about 120° C. to about 200° C., from about 130° C. to about 200° C., from about 140° C. to about 200° C., from about 150° C. to about 200° C., from about 160° C. to about 200° C., from about 170° C. to about 200° C., from about 180° C. to about 200° C., from about 100° C. to about 190° C., from about 100° C. to about 180° C., from about 110° C. to about 190° C., from about 110° C. to about 180° C., from about 120° C. to about 180° C., from about 130° C. to about 180° C., from about 140° C. to about 180° C., from about 145° C. to about 180° C., from about 150° C. to about 180° C., or from about 160° C. to about 180° C.

In other embodiments, the polycycloolefins have compressive strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa.

In other embodiments, the polycycloolefins have tensile strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa.

In other embodiments, the polycyclolefins have one or more of the properties listed above (e.g. glass transition temperature, compressive strength, and tensile strength).

The cyclic olefin is polymerized through ROMP polymerization process, which includes contacting the cyclic olefin with a metathesis catalysts, such as ruthenium or osmium catalysts. The cyclic olefin is polymerized while using a polymer processing technique to form the polycycloolefin cartridge casing. Suitable ruthenium and osmium carbene catalysts, the methods of synthesizing such catalysts, and suitable olefin monomers as well as the methods for performing and controlling the polymerization reaction, are disclosed in U.S. Pat. Nos. 5,312,940, 5,342,940, 5,849,851, 5,831,108, 5,917,071, 6,383,319, 6,410,110 and WO 97/20865, all of which are incorporated herein by reference. Generally suitable catalysts are ruthenium and osmium carbene complex catalysts disclosed in these references. Some ruthenium and osmium carbene complex catalysts may also include those which are stable in the presence of a variety of functional groups including hydroxyl, thiol, thioether, ketone, aldehyde, ester, ether, amine, imine, amide, nitro, carboxylic acid, disulfide, carbonate, isocyanate, carbodiimide, carboalkoxy, peroxo, anhydride, carbamate, and halogen. When the catalysts are stable in the presence of these groups, the starting monomers, impurities in the monomer, the coupling agents, any substituent groups on the catalyst, and other additives may include one or more of the listed groups without substantially deactivating the catalysts.

The catalysts may be of the general formula

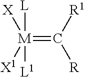

wherein;

M is ruthenium or osmium;

X and X¹ are each independently any anionic ligand;

L and L¹ are each independently any neutral electron donor ligand;

R and R¹ are each independently hydrogen or a substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀alkenyloxy, C₂-C₂₀alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl. Optionally, each of the R or R¹ substituent group may be substituted with one or more moieties selected from the group consisting of C₁-C₁₀alkyl, C₁-C₁₀ alkoxy, and aryl which in turn may each be further substituted with one or more groups selected from a halogen, a C₁-C₅ alkyl, C₁-C₅ alkoxy, and phenyl. Moreover, any of the catalyst ligands may further include one or more functional groups. Examples of suitable functional groups include but are not limited to: hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen.

In certain embodiments of these catalysts, the R substituent is hydrogen and the R¹ substituent is selected from the group consisting of C₁-C₂₀ alkyl, C₂-C₂₀ alkenyl, and aryl. In typical embodiments, the R¹ substituent is phenyl or vinyl, optionally substituted with one or more moieties selected from the group consisting of C₁-C₅ alkyl, C₁-C₅ alkoxy, phenyl, and a functional group. In other embodiments, the R¹ substituent is phenyl or —C═C(CH₃)₂.

In certain embodiments of these catalysts, L and L¹ are each independently selected from the group consisting of phosphine, sulfonated phosphine, phosphite, phosphinite, phosphonite, arsine, stibine, ether, amine, amide, imine, sulfoxide, carboxyl, nitrosyl, pyridine, and thioether. In typical embodiments, L and L¹ are each a phosphine of the formula PR³R⁴R⁵, where R³, R⁴, and R⁵ are each independently aryl or C₁-C₁₀ alkyl, particularly primary alkyl, secondary alkyl or cycloalkyl. In the other embodiments, L and L¹ ligands are each selected from the group consisting of -P(cyclohexyl)₃, -P(cyclopentyl)₃, -P(isopropyl)₃, and -P(phenyl)₃.

In certain embodiments of these catalysts, X and X¹ are each independently hydrogen, halide, or one of the following groups: C₁-C₂₀ alkyl, aryl, C₁-C₂₀ alkoxide, aryloxide, C₃-C₂₀ alkyldiketonate, aryldiketonate, C₁-C₂₀ carboxylate, arylsulfonate, C₁-C₂₃ alkylsulfonate, C₁-C₂₀ alkylthio, C₁-C₂₀ alkylsulfonyl, or C₁-C₂₀ alkylsulfinyl. Optionally, X and X¹ may be substituted with one or more moieties selected from the group consisting of C₁-C₁₀alkyl, C₁-C₁₀ alkoxy, and aryl which in turn may each be further substituted with one or more groups selected from halogen, C₁-C₅ alkyl, C₁-C₅ alkoxy, and phenyl. In typical embodiments, X and X¹ are halide, benzoate, C₁-C₅ carboxylate, C₁-C₅ alkyl, phenoxy, C₁-C₅ alkoxy, C₁-C₅ alkylthio, aryl, and C₁-C₅ alkyl sulfonate. In other embodiments, X and X¹ are each halide, CF₃CO₂, CH₃CO₂, CFH₂CO₂, (CH₃)₃CO, (CF₃)₂(CH₃)CO, (CF₃)(CH₃)₂CO, PhO, MeO, EtO, tosylate, mesylate, or trifluoromethanesulfonate. In the most preferred embodiments, X and X¹ are each chloride.

Particularly preferred catalysts can be represented by the formulas:

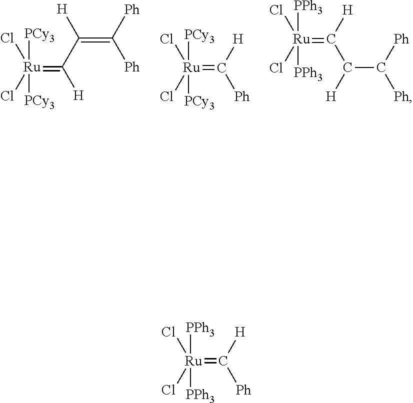

where Cy is cyclopentyl or cyclohexyl, and Ph is phenyl.

A typical catalyst can be represented by the formula:

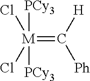

where Cy is cyclopentyl or cyclohexyl, and Ph is phenyl.

The catalysts described above are useful in polymerization of a wide variety of cyclic olefins through ROMP. Examples of commercial catalysts include PROXIMA™ CT 762, Grubbs Catalyst™ M37a (C884), Grubbs Catalyst™ M2a (C848), and Hoveyda-Grubbs Catalyst™ M72 (C627).

The ROMP polymerization of the cyclic monomer may occur either in the presence or absence of solvent and may optionally include other additives. Additives may include, without being limited thereto, antistatics, antioxidants (primary antioxidants, secondary antioxidants, or mixtures thereof), light stabilizers, plasticizers, dyes, pigments, fillers, reinforcement materials, lubricants, adhesion promoters, viscosity-increasing agents, viscosity-decreasing agents and demolding enhancers. In addition, other additives may include materials that modulate the activity of the catalyst (e.g. to either retard the activity such as triphenylphosphone or to enhance the activity).

In embodiments, the reaction can be conducted in the absence of a solvent. However, solvents may be used such as organic, protic, or aqueous solvents which are typically inert under the reaction conditions. Examples of suitable solvents may include aromatic hydrocarbons, chlorinated hydrocarbons, ethers, aliphatic hydrocarbons, alcohols, water, or mixtures thereof.

With respect to reinforcement materials, the resultant polycycloolefins may be reinforced or unreinforced. Suitable reinforcing materials include those that add to the strength or stiffness of the cartridge casing when incorporated with the polymer. Reinforcing material can be in the form of filaments, fibres, rovings, mats, weaves, fabrics, or other known structures and composites. In typical embodiments, the reinforcing material is in filament or fibre form such as, for example, metal or carbon fibres (e.g. Toray T700S (50C Sizing), Zoltek™ PX 35, Mitsubishi Rayon Grafil™ TM Carbon fiber 34-700 24K (K sizing), and SGL C U320-0/ST or SGL C B300-090/ST).

Representative suitable reinforcement materials include barium sulfate; minerals, such as glass, carbon, graphite, ceramic, boron, and the like; metallic materials; organic polymers, such as aromatic polyamides including the aramid fibers, such as Kevlar®, and polybenzimide, polybenzoxazol, polybenzothiazol, polyesters, and the like; polyolefins; fluoropolymer, such as Halar®; cellulosic materials; and other material known to be useful as reinforcing material for polymer systems. Examples of other commercially available reinforcing materials include the following products: Fiberfrax® from Unifrax Corporation, Interfile from Akzo Nobel, and wollastonite from Nyco. Fiber glass or fiber glass knitted into a fabric are preferred. Examples include: PPG Hybon® 2026, Owens Corning SE 1200, and 3B SE 3030. The reinforcing materials may be “sized”, i.e., treated or coated with a coupling agent, often also referred to as a sizing or bonding agent, to render them more compatible for adhering with the olefin polymer matrix. As used herein, “coupling agent” means any material that can be applied to a reinforcing material that improves adhesion/wetout between the reinforcement materials and the polyolefin. Suitable coupling agents include a variety of conventional chromium; silane; titanate; zirconate, zirco-aluminate, and hydroxyl terminated amphaphilic coupling agents. Preferably, those which do not contain the following functionalities: vinyl ethers; active oxygen functionalities such as hydroperoxides or activated epoxides; acetylenes; and other Lewis bases that may poison or adversely affect the ruthenium or osmium catalyst.

The parameters for the metathesis polymerization reactions used, such as the atmosphere, the ratio of catalyst to cyclic olefin, the reaction temperatures, the solvents that may be used, the additives and other agents that may be present during the polymerization reaction, and the methods for carrying out the metathesis polymerization are discussed in the incorporated references identified above. Generally, the polymerization of the cyclic olefin is carried out by adding the desired metathesis catalyst to the monomer starting material which has been heated to a starting resin temperature. Alternatively, the catalyst may be first added to the monomer starting material and the mixture then heated to the required temperature. The temperature may affect the rate of the polymerization reaction. Generally, the reaction temperature will be in the range of about 10° C. to about 500° C., and typically, about 25° C. to about 450° C.

Any suitable ratio of catalyst to cyclic olefin may be used. The ratio of catalyst to cyclic olefin may be within the range from about 1:5 to about 1:100 (wt/wt). Various example of ratios of catalyst to cyclic olefin is from about 1:10 to about 1:100 (wt/wt), from about 1:15 to about 1:100 (wt/wt), from about 1:20 to about 1:100 (wt/wt), from about 1:25 to about 1:100 (wt/wt), from about 1:30 to about 1:100 (wt/wt), from about 1:35 to about 1:100 (wt/wt), from about 1:40 to about 1:100 (wt/wt), from about 1:45 to about 1:100, from about 1:50 to about 1:100 (wt/wt), from about 1:55 to about 1:100 (wt/wt), from about 1:60 to about 1:100 (wt/wt), from about 1:70 to about 1:100 (wt/wt), from about 1:80 to about 1:100 (wt/wt), from about 1:10 to about 1:90 (wt/wt), from about 1:15 to about 1:80 (wt/wt), from about 1:20 to about 1:70 (wt/wt), from about 1:25 to about 1:65 (wt/wt), from about 1:30 to about 1:65 (wt/wt), from about 1:35 to about 1:65 (wt/wt), from about 1:40 to about 1:65 (wt/wt), from about 1:45 to about 1:60, from about 1:50 to about 1:60 (wt/wt), or from about 1:50 to about 1:55 (wt/wt). The method may be practiced using catalyst/cyclic olefin ratios outside of the above ranges.

After polymerization is complete (e.g., after the cartridge case has “cured”) the polyolefin cartridge case may be post cured to initiate increased cross-linking. Additional cross-linking may be accomplished by post-curing at an elevated temperature (e.g. about 100° C. to about 120° C. for a suitable time, such as about 1 hour). Other methods may be used to post-cure the polyolefin material. The cyclic olefin may optionally include one or more cross-linking agents for initiating additional post cure cross-linking of the polyolefin.

Reaction Injection Molding (RIM) can be employed as the polymerization process. In this process, the cyclic olefin may be injected and polymerization can take place inside a mold. This can produce parts with fine detail and finishes and can also incorporate infused composite reinforcements that may not be possible with thermoplastics due to their high melt viscosities. In an embodiment, the method for making an ammunition cartridge case comprises reaction injection molding (RIM), wherein a composition comprises a cyclic olefin and a metathesis catalyst is injected into a mold for an ammunition cartridge case and the cyclic olefin undergoes the ROMP reaction to form an ammunition cartridge case. Any other suitable method may be used to form the ammunition cartridge case comprising polycycloolefin derived from ring-opening metathesis polymerization (ROMP) reaction of a cyclic olefin using any of the suitable cyclic olefins, temperatures, and ratios of starting materials disclosed herein.

### Examples of Mold Apparatus for Manufacturing the Ammunition Cartridge Casing

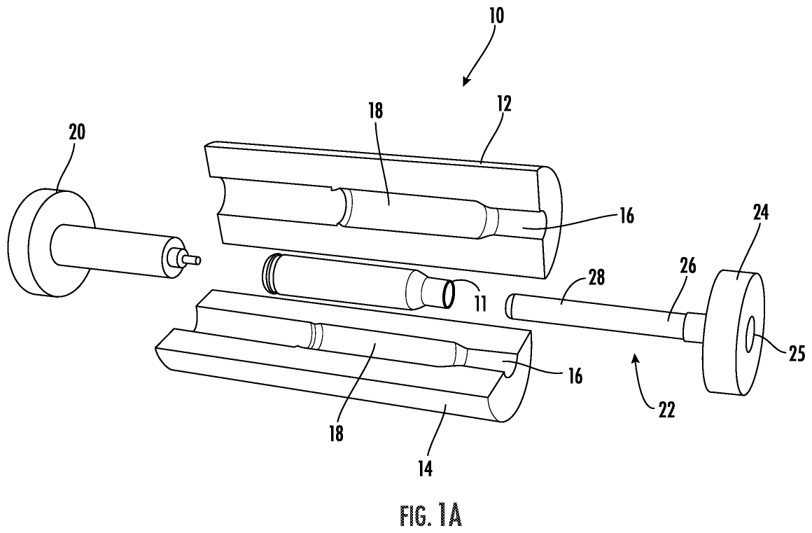

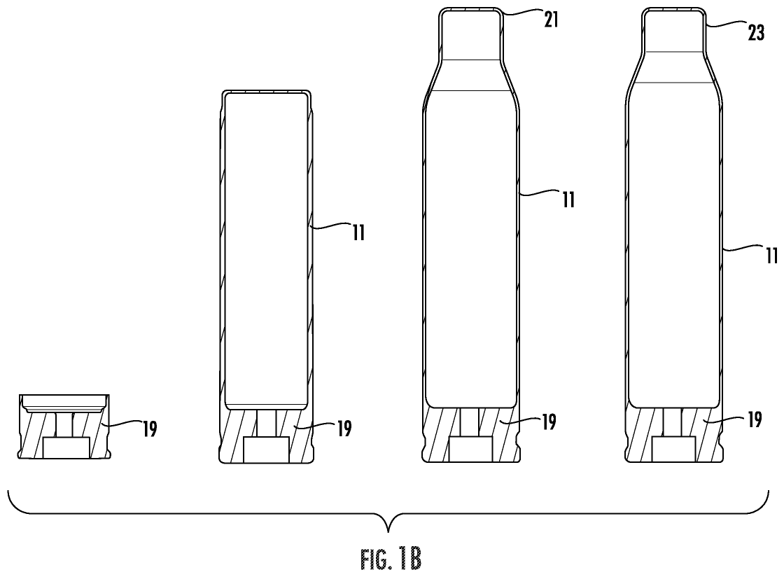

FIG. 1A shows an exemplary mold 10 for manufacturing polymer ammunition cartridge cases, which can eliminate the customary metal cartridge base and allows for molding the cartridge case 11 as a continuous part. The mold may have two sections 12, 14 which may be formed to have a hollow substantially cylindrical channel 16 forming the molding chamber 18 therebetween when the sections 12, 14 are combined. The two sections 12, 14 may be formed from any suitable material for molding and examples may include a high strength, high temperature resistant material, various metals and metal alloys.

A pre-formed insert 19 may be inserted into one end of the molding chamber 18 in order to provide the casing with adequate pressure capability while reducing the mass and promoting proper primer seating, as shown in FIG. 1B. Generally, the use of the pre-formed insert 19 is dependent on the desired level of strength of the casing. The insert 19 becomes infused during the molding process, and may act as a reinforcement. The insert 19 can be a preformed 2D or 3D fiber such as carbon or Kevlar etc. Alternatively, the insert 19 may be made of a porous, composite, and/or low mass metal. The insert 19 can also be a solid metal or composite piece that is over-molded (e.g. insert molded) to obtain similar results.

FIG. 1B also shows an example of the cartridge, which can have a neck 21 or 23 that can be made from, for example, metallized (or long fiber injection molded or compression molded) polymer or metal. Neck 21 can be inserted post ejection from the mold. Neck 23 may be inserted prior to the molding process and may be partially over-molded.

In FIG. 1A, an injector 20 may be placed at the end of the mold 10 where the insert 19 was positioned, for injecting cyclic olefin resin to fill the molding chamber 18, into the channel 16. An expandable core 22 may be placed at the other end of the mold 10, and into the channel 16.

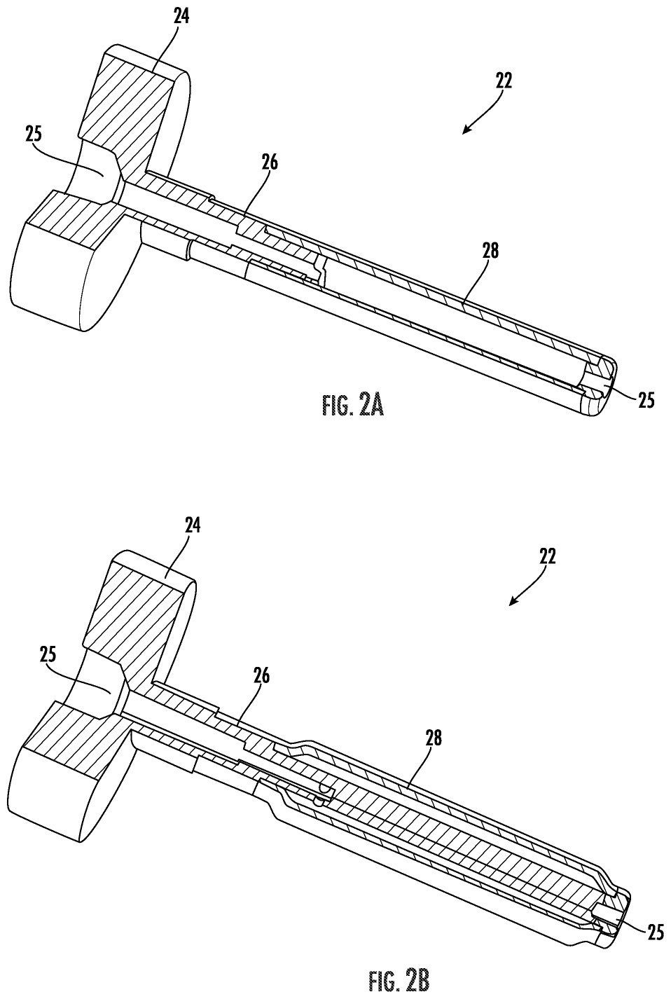

FIG. 2A shows the exemplary expandable core 22. The core 22 has a top 24 and a mandrel 26, the top 24 and mandrel 26 having a substantially cylindrical channel 25 therethrough. The mandrel 26 may have a bladder 28 which is expandable or inflatable as shown in FIG. 2B, using fluid (e.g. liquid or air) to inflate.

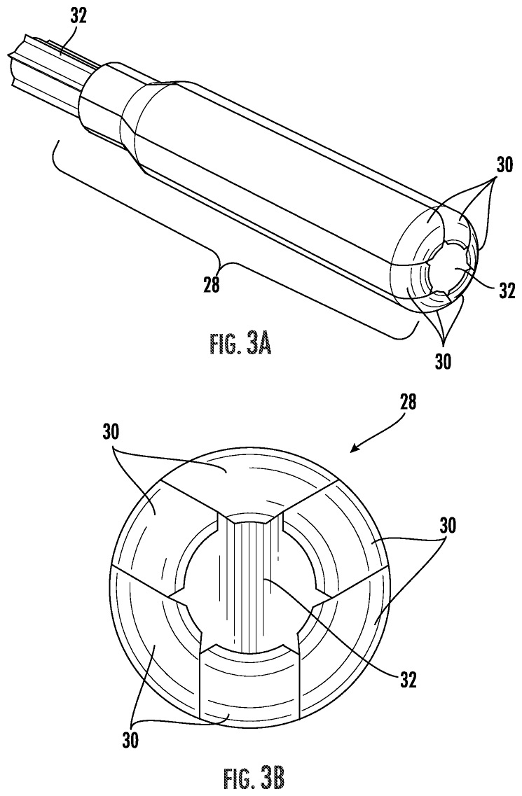

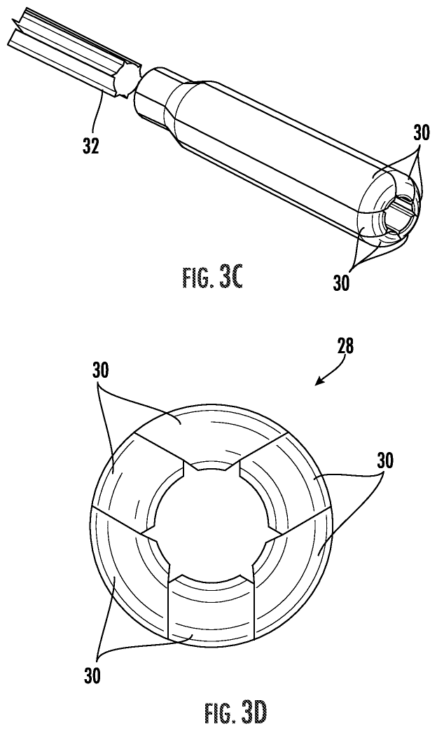

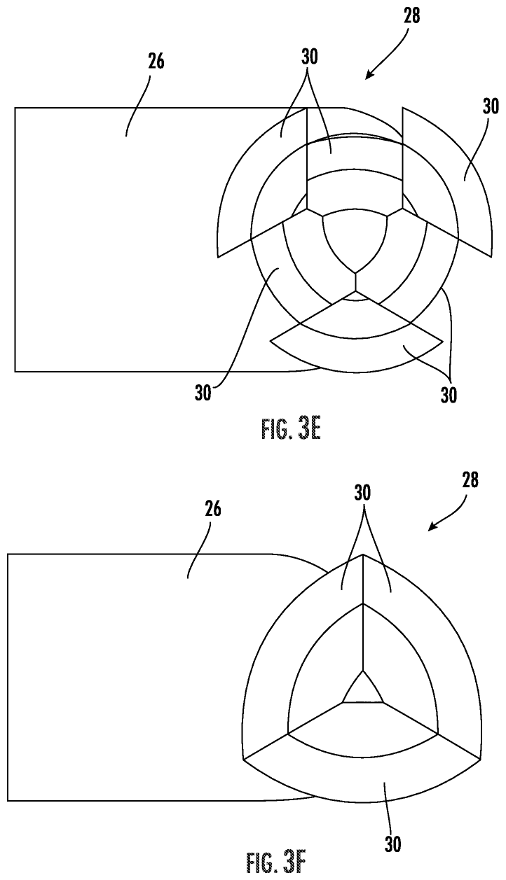

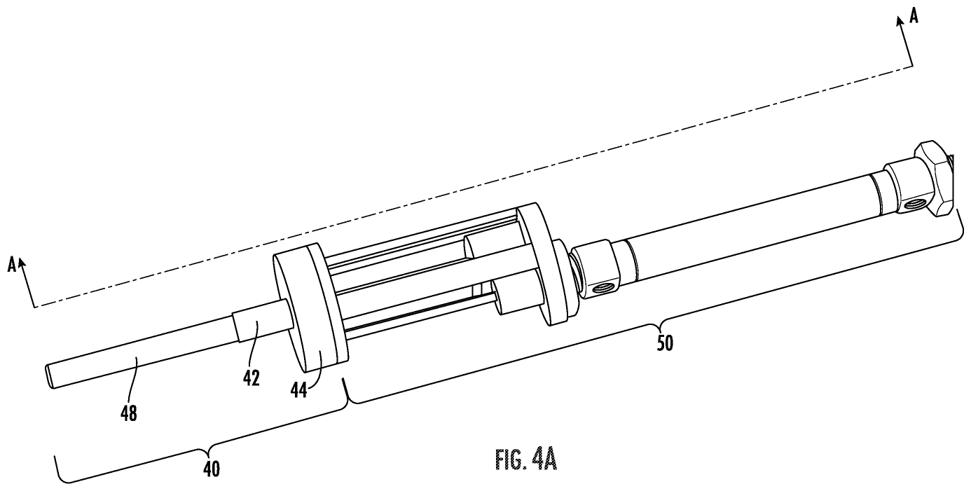

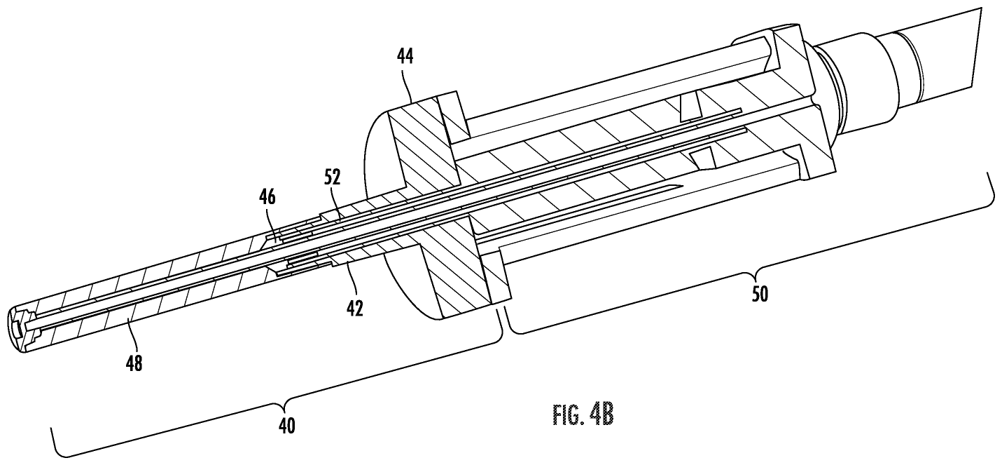

FIGS. 3A to 3F show an embodiment of the expandable core 22. FIG. 3A shows a perspective view of the expandable core 22 in the inflated state. FIG. 3B shows an end view of the expandable core 22 in the inflated state. The bladder 28 comprises a plurality of segments 30. An activator pin 32 may be inserted into the mandrel 26, causes the segments 30 of the bladder 28 to slide into place around the mandrel 26. In some embodiments, the activator pin 32 may be filled with fluid (e.g. liquid or air) to cause the bladder 28 to expand. When the activator pin 32 is removed from the mandrel 26, as depicted in FIGS. 3C and D, the segments 30 collapse to deflate the core 22, as depicted in FIGS. 3E and 3F. The bladder may be made from any suitable material.

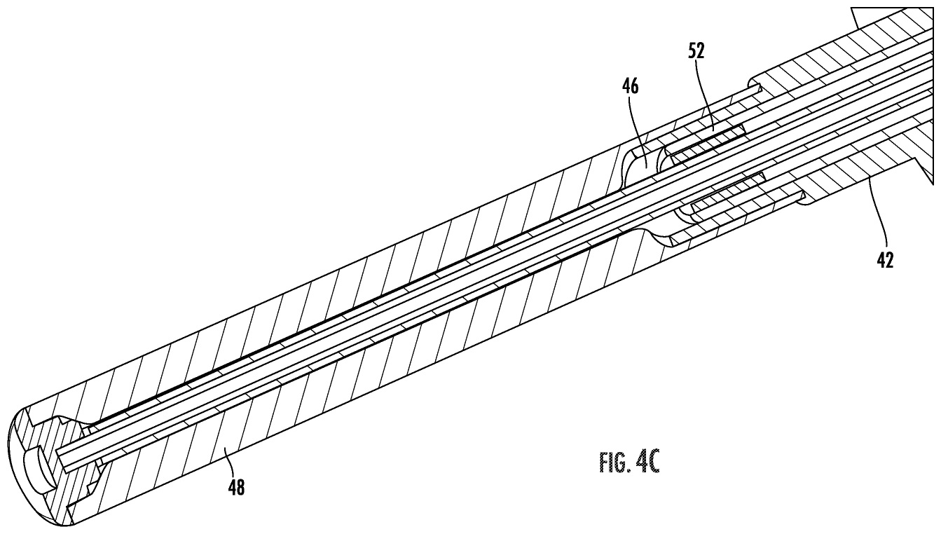

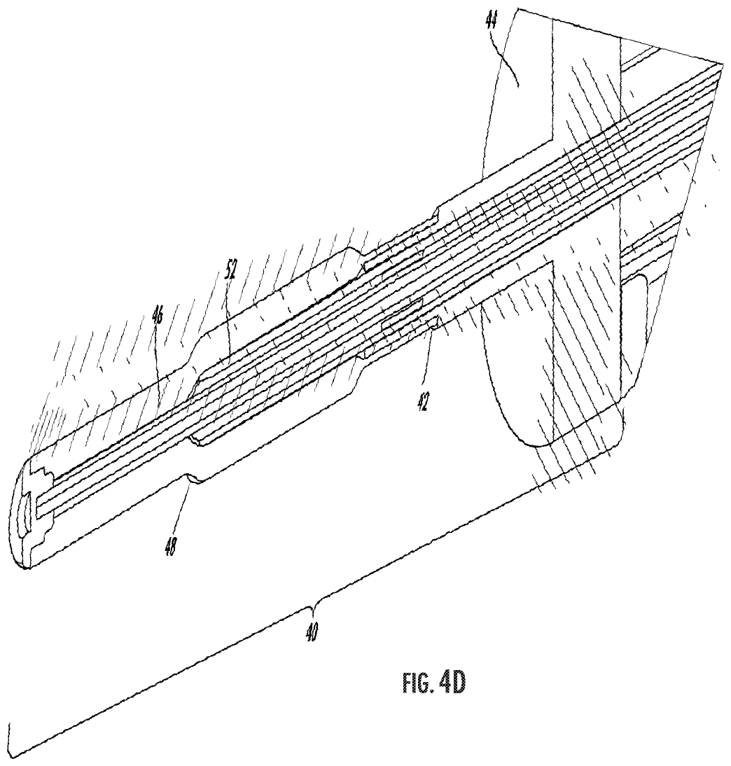

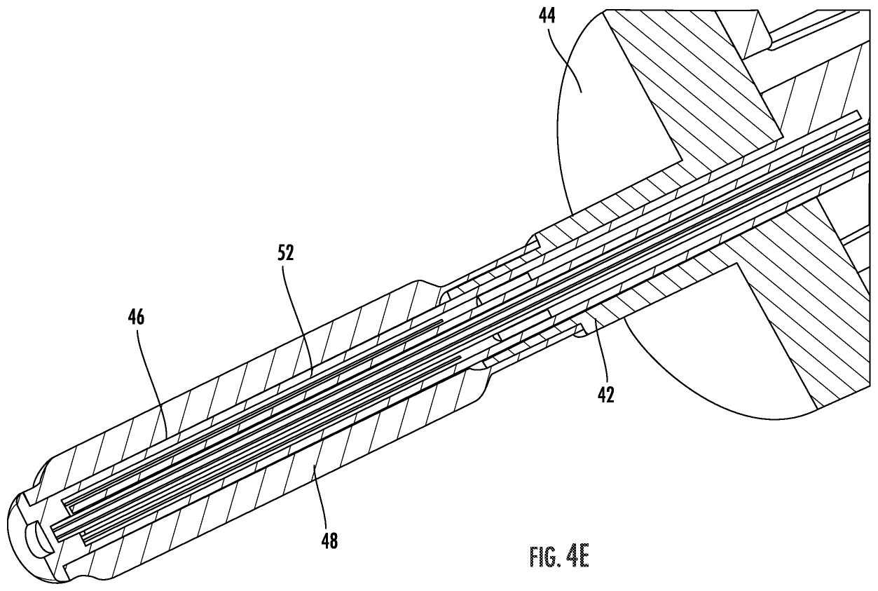

FIGS. 4A to 4E show an alternative embodiment of the expandable core 40. FIG. 4A shows the core 40 in its deflated state. The core 40 in this embodiment also comprises a mandrel 42 and a top 44 having a channel 46 running therethrough. An inflatable or expandable silicone bladder 48 surrounds the circumferential surface of the mandrel 42. An inflating device is connected to the top 44 of the expandable core 40. FIG. 4B shows a sectional view of the core 40 and the inflating device 50 along the A-A line of FIG. 4A. The inflating device 50 is inserted into the channel 46 of the core 40. FIG. 4C shows a close-up view of the internal components of the silicone bladder 48. FIG. 4D shows a close-up view of the bladder 48 as it is being inflated. The inflating device 50 discharges an amount of fluid (e.g. liquid or air) into the bladder 48 acting as a fluid bearing. As the fluid is discharged into the bladder 48 a substantially cylindrical tube 52 is slid from the inflating device into the bladder 48 to expand the bladder 48 further, as shown in FIG. 4D. The tube 52 acts to positively displace the fluid into a particular shape and size. Mica may be deposited on the silicone to control the concentricity of the bladder 48 when fully inflated, as shown in FIG. 4E.

The inflatable or expandable bladder 28 or 48 may be made from any suitable material, which can include an expandable material such as, for example, elastomer (e.g. silicone, urethane, etc.).

### Examples of Systems for Manufacturing the Ammunition Cartridge Casing

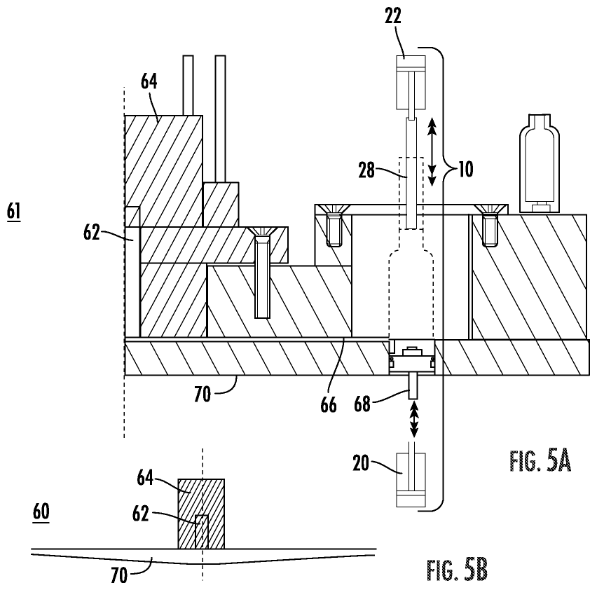

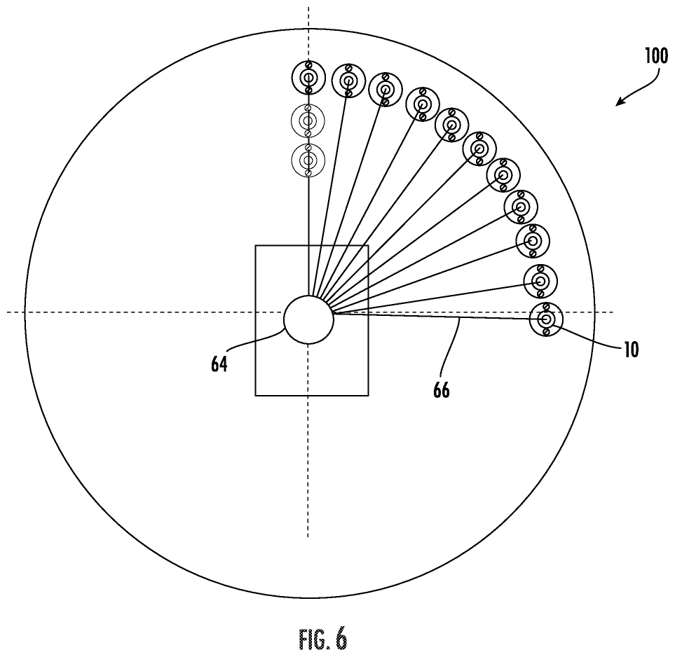

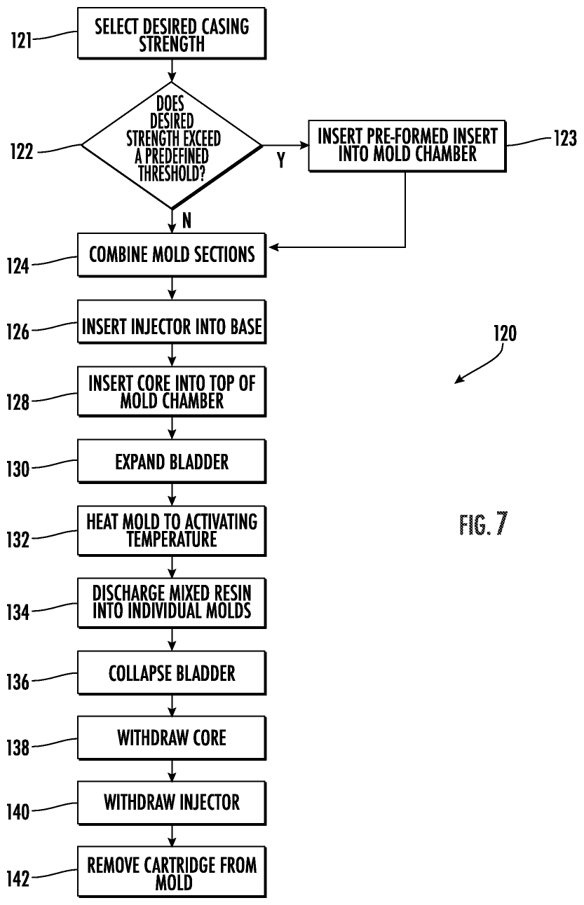

FIGS. 5A and 5B show an exemplary system 60 for manufacturing a cartridge case using, for example, cyclic olefins. FIG. 5A is a sectional drawing along the centerline of FIG. 5B, which shows a side view of the system 60. FIG. 5A shows a portion 61 of system 60. FIG. 5A shows a portion of the mix head 64 and a possible arrangement of a runner 66 from the mix head 64 to a mold 10. The mold 10 is placed in the system 60. While FIG. 5A shows the core 22 being utilized with the system 60, it is understood that core 40 may also be used. A resin reservoir 62 containing, for example, the cyclic olefin and catalyst (e.g. resin), which is injected into the mold 10 when the injector 20 is raised into the bottom of the mold 10. The expandable core 22 is lowered into molding chamber 18, and the silicone bladder 28 is expanded. The cyclic olefin and catalyst (e.g. resin) may be combined in mix head 64, and the resin mixture is transferred via the runners 66 to the transfer piston 68 at the base 70 of the mold cavity then forced into the mold when the piston 68 is moved upward, as shown in FIGS. 5 and 6. Polymerization takes place within the mold, producing a cartridge case.

A Cannon A-100 RIM machine may be implemented in this system 60 to mix the resin.

FIG. 5B shows a side view of system 60, which may have a circular, mix gate design. FIG. 5B shows the mix head 64 having a reservoir 62, from which runners (FIG. 5A) extend radially outwards to molds (FIG. 5A) in the base 70, which may narrow towards the molds.

FIG. 6 shows a top view of an exemplary system 100 arrangement for multiple molds 10 to make a plurality of cartridge cases simultaneously. In this example, a plurality of runners 66 extend radially from the mix head 64 to a plurality of molds 10. In other embodiments of the system, the system may include direct injection into the mold (e.g. without utilizing the mix head 64 and the runners 66). The injection may be simultaneous injection into each of the molds or a sequential injection into each mold from, for example, a single injector.

### Examples of Methods for Utilizing the Apparatus/System for Manufacturing the Ammunition Cartridge Casing

FIG. 7 shows an exemplary method 120 of manufacturing polymer ammunition cartridge cases. In step 121, a desired strength of the casing is selected. Next, in step 122, a determination is made as to whether the desired strength of the casing exceeds a predefined range or threshold in order to determine if an insert is needed. When the desired strength of the casing exceeds a predefined range or threshold then the process proceeds to step 123, in which the pre-formed insert 19 is inserted into the mold chamber, otherwise the process proceeds to step 124 in which the mold sections are combined. Next, from step 123 or 124, the injector 20 is inserted into the base 70 in step 126. In step 128, the expandable core 22 (expandable core 40 can also be used) is inserted into the top of the mold 10. In step 130, the bladder 28 (or bladder 48) is expanded. In step 132, the mold 10 is heated to the activation temperature of the cyclic olefin and catalyst (e.g. resin) to initiate the ROMP reaction if ROMP reaction desired. Next, in step 134, the mix head 64 discharges mixed resin 62 through runner gates into individual molds 10, and the piston 68 is raised to cut off runner gate 66 and the resin polymerizes. In step 136, the bladder 28 (or bladder 48) is collapsed. In step 138, the core 22 (or core 40) is withdrawn. In step 140, the injector 20 is removed. In step 142, the formed cartridge case is removed from the mold 10. The mold 10 may be cleaned by heating the mold to a range of between about 450° C. to 700° C.

In another exemplary method, prior to expanding the bladder 28 (or bladder 48) in step 130 of FIG. 7, the mold 10 can be heated to the activation temperature before or after expansion of the bladder. The mix head 64 can discharge the mixed resin 62 through runner gates into individual molds 10, and the piston 68 is raised to cut off runner gate 66. The bladder 28 (or bladder 48) is then expanded and the resin polymerizes. The bladder 28 (or bladder 48) is collapsed and the core 22 (or core 40) is withdrawn. The injector 20 is removed and the formed cartridge case is removed from the mold 10.

If the resin is used, the ratio of cyclic olefin to catalyst may be in any suitable ratio, such as the various ratios described above. In specific embodiments, the ratio is about 50:1. ROMP polymerization is exothermic, and therefore the mold temperature may be controlled to optimize processing temperature. Temperature optimization for polymerization may be achieved using a water temperature controller that circulates through channels in the mold structure. Temperatures may be any suitable temperature range to initiate the ROMP polymerization. This may depend on the cyclic olefins and the catalyst, desired process time, resin viscosity, etc. In other embodiments, the activation temperature may be from about 30° C. to about 200° C. and typically, from about 180° C. to about 200° C.

A projectile (e.g. bullet) may be added to the cartridge case. The bullet may be made of steel, stainless steel or any other suitable or conventional material.

This method can allow the neck of the cartridge case to have a metallized (or long fiber injection molded or compression molded) polymer or metal neck that can be post inserted or inserted prior to ejection from the mold. Metallized polymers may be used and size well and exhibit reduced creep.

This molding approach may also permit the inclusion of a thin-walled flame tube directly into the case during the injection molding cycle. Flame tubes are often used in front ignition, medium caliber rounds but have been shown to improve the ballistics in some smaller calibers in testing. Molding the flame tube as part of the case would be a cost-effective method to produce such a configuration as secondary parts and processes are eliminated.

Using the polycycloolefin, apparatus, system, and method described herein, it is possible to design a cartridge case having a neck that retains, for example, a metallized (or long fiber injection molded or compression molded) polymer or metal neck that can be post inserted or inserted prior to ejection from the mold. Metallized polymers have been shown to size well and exhibit reduced creep. Still, the overall effect on mass may be low as the percentage of metal is small when compared to a polymer case that uses a metal base. This approach also permits the use of existing loading equipment and methods.

Patent applications, patents, and publications are cited herein to assist in understanding the embodiments described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

Although specific embodiments of the invention have been disclosed herein in detail, it will be understood by those skilled in the art that variations may be made thereto without departing from the spirit of the invention or the scope of the appended claims.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. An ammunition cartridge case comprising polycycloolefin derived from ring-opening metathesis polymerization (ROMP) reaction of a cyclic olefin.

2. The cartridge case of claim 1, wherein the polycycloolefin derived from ROMP comprises linear polycycloolefin(s), branched polycycloolefin(s), crosslinked polycycloolefin(s), linear copolymers of cycloolefin(s), branched copolymers of cycloolefin(s), crosslinked copolymers of cycloolefin(s), or a combination thereof.

3. The cartridge case of claim 1 or 2, wherein the polycycloolefin has high strength, toughness and chemical resistance over a temperature range from about −50° C. to about 180° C.

4. The cartridge case of any one of claims 1 to 3, wherein the polycycloolefin combines the chemical attributes of one or more of thermoplastics, thermosets and fluoropolymers.

5. The cartridge case of any one of claims 1 to 4, wherein the polycycloolefin has a glass transition temperature of from about 100° C. to about 200° C.; from about 110° C. to about 200° C., from about 120° C. to about 200° C., from about 130° C. to about 200° C., from about 140° C. to about 200° C., from about 150° C. to about 200° C., from about 160° C. to about 200° C., from about 170° C. to about 200° C., from about 180° C. to about 200° C., from about 100° C. to about 190° C., from about 100° C. to about 180° C., from about 110° C. to about 190° C., from about 110° C. to about 180° C., from about 120° C. to about 180° C., from about 130° C. to about 180° C., from about 140° C. to about 180° C., from about 145° C. to about 180° C., from about 150° C. to about 180° C., or from about 160° C. to about 180° C.

6. The cartridge case of any one of claims 1 to 5, wherein the polycycloolefin has a compressive strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa.

7. The cartridge case of any one of claims 1 to 6, wherein the polycycloolefin has a tensile strength of from about 30 MPa to about 150 MPa, from about 40 MPa to about 150 MPa, from about 50 MPa to about 150 MPa, from about 60 MPa to about 150 MPa, from about 70 MPa to about 150 MPa, from about 80 MPa to about 150 MPa, from about 90 MPa to about 150 MPa, from about 50 MPa to about 130 MPa, from about 50 MPa to about 120 MPa, from about 50 MPa to about 110 MPa, from about 50 MPa to about 100 MPa, from about 60 MPa to about 100 MPa, from about 70 MPa to about 100 MPa, or from about 80 MPa to about 100 MPa.

8. The cartridge case of any one of claims 1 to 7, wherein the cyclic olefin is Reaction Injection Molded (RIM) material.

9. The cartridge case of any one of claims 1 to 8, wherein the cyclic olefin has a viscosity ranging greater than about 0 cP to about 1000 cP at 25 from about 0.5 cP to about 1000 cP at about 25° C.; from about 0.5 cP to about 900 cP at about 25° C., from about 0.5 cP to about 800 cP at about 25° C., from about 0.5 cP to about 700 cP at about 25° C., from about 0.5 cP to about 600 cP at about 25° C., from about 0.5 cP to about 500 cP at about 25° C., from about 0.5 cP to about 400 cP at about 25° C., from about 0.5 cP to about 300 cP at about 25° C., from about 0.5 cP to about 200 cP at about 25° C., from about 0.5 cP to about 100 cP at about 25° C. from about 0.5 cP to about 50 cP at about 25° C., from about 0.5 cP to about 25 cP at about 25° C., from about 0.5 cP to about 20 cP at about 25° C. from about 0.5 cP to about 10 cP at about 25° C., from about 0,5 cP to about 5 cP at about 25° C., from about 0.5 cP to about 3 GP at about 25° C., from about 0.5 cP to about 2 cP at about 25° C., from about 0.9 cP to about 1000 cP at about 25° C. from about 0.9 cP to about 900 cP at about 25° C., from about 0.9 cP to about 800 cP at about 25° C., from about 0.9 cP to about 700 cP at about 25° C., from about 0.9 cP to about 600 cP at about 25° C., from about 0.9 cP to about 600 GP at about 25° C., from about 0.9 cP to about 400 cP at about 25° C., from about 0.9 cP to about 300 cP at about 25° C., from about 0.9 cP to about 200 cP at about 25° C., from about 0.9 cP to about 100 cP at about 25° C., from about 0.9 cP to about 50 cP at about 25° C., from about 0.9 cP to about 25 cP at about 25° C., from about cP to about 20 cP at about 25° C., from about 0.9 cP to about 10 cP at about 25° C., from about 0.9 cP to about 5 cP at about 25° C., from about 0.9 cP to about 3 cP at about 25° C., from about 200 cP to about 300 cP at about 25° C., from about 900 cP to about 950 cP at about 25° C., less than about 35 cP at about 25° C., less than about 10 cP at about 25° C., or less than about 8 cP at about 25° C.

10. The cartridge case of any one of claims 1 to 8, wherein the cyclic olefin has a viscosity that is substantially the same as the viscosity of water at about 25° C.

11. The cartridge case of any one of claims 1 to 10, wherein the cyclic olefin comprises substituted or unsubstituted monocyclic olefin, substituted or unsubstituted polycyclic olefin, or a combination thereof, optionally including heteroatom(s) and/or functional group(s) thereof.

12. The cartridge case of any one of claims 1 to 11, wherein the cyclic olefin comprises substituted or unsubstituted strained monocyclic olefin, substituted or unsubstituted strained polycyclic olefin, substituted or unsubstituted unstrained monocyclic olefin, substituted or unsubstituted unstrained polycyclic olefin, or a combination thereof, optionally including heteroatom(s) and/or functional group(s) thereof.

13. The cartridge case of any one of claims 1 to 12, wherein the cyclic olefin comprises dicyclopentadiene (DCPD) resins, Lyondell™ 108, Lyondell™ 103, PROXIMA™ HPR 2029, PROXIMA™ HPR 2102, PROXIMA™ ACR 4100, PROXIMA™ HPR 2128, ethylidenenorbornene, methyltetracyclododecene, methyl norbornene, ethylnorbornene, dimethylnorbornene, norbornadiene, cyclopentene, cycloheptene, cyclooctene, 7-oxanorbornene, 7-oxanorbornene derivatives, 7-oxabicyclo[2.2.1]hept-5ene derivatives, 7-oxanorbornadiene, cyclododecene, 2-norbornene, also named bicyclo[2.2.1]-2-heptene and substituted bicyclic norbornenes, 5-methyl-2-norbornene, 5,6-dimethyl-2-norbornene, 5-ethyl-2-norbornene, 5-butyl-2-norbornene, 5-hexyl-2-norbornene, 5-octyl-2-norbornene, 5-dodecyl-2-norbornene, 5-isobutyl-2-norbornene, 5-octadecyl-2-norbornene, 5-isopropyl-2-norbornene, 5-phenyl-2-norbornene, 5-p-toluyl-2-norbornene, 5-a-naphthyl-2-norbornene, 5-cyclohexyl-2-norbornene, 5,5-dimethyl-2-norbornene, dicyclopentadiene (or cyclopentadiene dimer), dihydrodicyclopentadiene (or cyclopentene cyclopentadiene codimer), methyl-cyclopentadiene dimer, ethyl-cyclopentadiene dimer, tetracyclododecene, also named 1,2,3,4,4a,5,8,8a-octahydro-1,4:5,8-dimethyanonaphthalene, 9-methyl-tetracyclo[6.2.1.1^{3,6}.0^{2,7}]-4-dodecene, also named 1,2,3,4,4a,5,8,8a-octahydro-2-methyl-4,4:5,8-dimethanonaphthalene, 9-ethyl-tetracyclo[6.2.1.1^{3,6}.0^{2,7}]-4-dodecene, 9-propyl-tetracyclo[6.2.1.1^{3,6}.0^{2,7}]-4-dodecene, 9-hexyl-tetracyclo[6.2.1.1^{3,6}.0^{2,7}]-4-dodecene, 9-decyl-tetracyclo[6.2.1.1^{3,6}.0^{2,7}]-4-dodecene, 9,10-dimethyl-tetracyclo[6.2.1.1^{3,6}.0^{2,7}]-4-dodecene, 9-ethyl, 10-methyl-tetracyclo[6.2.1.1^{3,6}.0^{2,7}]-4-dodecene, 9-cyclohexyl-tetracyclo[6.2.1.1^{3,6}.0^{2,7}]-4-dodecene, 9-chloro-tetracyclo[6.2.1.1^{3,6}.0^{2,7}]-4-dodecene, 9-bromo-tetracyclo[6.2.1.1^{3,6}.0^{2,7}]-4-dodecene, cyclopentadiene-trimer, methyl-cyclopentadiene-trimer, derivative(s) thereof, or a combination thereof, optionally including heteroatom(s) and/or functional group(s) thereof.

14. The cartridge case of any one of claims 1 to 13, wherein the cyclic olefin is selected from substituted or unsubstituted norbornene, substituted or unsubstituted norbornadiene, substituted or unsubstituted dicyclopentadiene, substituted or unsubstituted cyclobutene, substituted or unsubstituted cyclopentene, substituted or unsubstituted cycloheptene, substituted or unsubstituted cyclooctene, substituted or unsubstituted cyclononene, substituted or unsubstituted cyclodecene, substituted or unsubstituted cyclooctadiene, substituted or unsubstituted cyclononadiene, substituted or unsubstituted cyclododecene, substituted or unsubstituted 7-oxanorbornene, substituted or unsubstituted 7-oxanorbornadiene, derivative(s) therefrom, or a combination thereof, optionally including heteroatom(s) and/or functional group(s) thereof.

15. The cartridge case of any one of claims 1 to 14, wherein the cyclic olefin is selected from substituted or unsubstituted norbornene, substituted or unsubstituted dicyclopentadiene, a homolog thereof, a derivative thereof, or a combination thereof, optionally including heteroatom(s) and/or functional group(s) thereof.

16. The cartridge case of any one of claims 1 to 15, wherein the cyclic olefin comprises dicyclopentadiene (DCPD), such as endo-DCPD, and the polycycloolefin comprises poly-DCPD, wherein the poly-DCPD comprises non-crosslinked poly-DCPD and/or crosslinked poly-DCPD, optionally including functional group(s).

17. The cartridge case of any one of claims 1 to 16 further comprising a reinforcement material.

18. The cartridge case of claim 17, wherein the reinforcement material adds further strength and/or further stiffness to the cartridge casing.

19. The cartridge case of claim 17 or 18, wherein the reinforcement material is selected from woven and/or non-woven material.

20. The cartridge case of any one of claims 17 to 19, wherein the reinforcement material is selected from filament(s), fibre(s), roving(s), mat(s), weave(s), fabric(s), metal(s), metal alloy(s), composite(s), or a combination thereof.

21. The cartridge case of any one of claims 17 to 20, wherein the reinforcement material is selected from filament(s) and/or fibre(s).

22. The cartridge case of any one of claims 17 to 21, wherein the reinforcement material is selected from metal(s), metal alloy(s), carbon fibre(s), or a combination thereof.

23. A projectile comprising the cartridge case of any one of claims 1 to 22.

24. A method for making a cartridge case as defined in any one of claims 1 to 23, the method comprising:
heating the cyclic olefin and a metathesis catalyst, in a mold of the cartridge case, to a temperature whereby the cyclic olefin undergoes the ROMP reaction to form the polycycloolefin cartridge case.

25. A method for making a cartridge case as defined in any one of claims 1 to 23, the method comprising:
heating the cyclic olefin, in a mold of the cartridge case, to a temperature whereby the cyclic olefin will undergo the ROMP reaction to form the polycycloolefin once a metathesis catalyst is added; and
adding the metathesis catalyst to the cyclic olefin to form the polycycloolefin cartridge case.

26. A method for making the cartridge case as defined in any one of claims 1 to 23, the method comprising:
injecting a composition comprising the cyclic olefin and a metathesis catalyst into a mold of the cartridge case; and
heating the composition, in the mold of the cartridge case, to a temperature whereby the cyclic olefin undergoes the ROMP reaction to form the polycycloolefin cartridge case.

27. The method of any one of claims 24 to 26, wherein the method comprises reaction injection molding (RIM).

28. The method of any one of claims 24 to 27, wherein the heating comprises heating the mold.

29. The method of any one of claims 24 to 28, wherein the temperature is from about 10° C. to about 500° C. or from about 25° C. to about 450° C.

30. The method of any one of claims 24 to 29, wherein a ratio of the catalyst to the cyclic olefin is from about 1:5 to about 1:100 (wt/wt), from about 1:10 to about 1:100 (wt/wt), from about 1:15 to about 1:100 (wt/wt), from about 1:20 to about 1:100 (wt/wt), from about 1:25 to about 1:100 (wt/wt), from about 1:30 to about 1:100 (wt/wt), from about 1:35 to about 1:100 (wt/wt), from about 1:40 to about 1:100 (wt/wt), from about 1:45 to about 1:100, from about 1:50 to about 1:100 (wt/wt), from about 1:55 to about 1:100 (wt/wt), from about 1:60 to about 1:100 (wt/wt), from about 1:70 to about 1:100 (wt/wt), from about 1:80 to about 1:100 (wt/wt), from about 1:10 to about 1:90 (wt/wt), from about 1:15 to about 1:80 (wt/wt), from about 1:20 to about 1:70 (wt/wt), from about 1:25 to about 1:65 (wt/wt), from about 1:30 to about 1:65 (wt/wt), from about 1:35 to about 1:65 (wt/wt), from about 1:40 to about 1:65 (wt/wt), from about 1:45 to about 1:60, from about 1:50 to about 1:60 (wt/wt), or from about 1:50 to about 1:55 (vvt/wt).

31. The method of any one of claims 24 to 30, wherein the metathesis catalyst is a ruthenium and/or osmium metathesis catalyst.

32. The method of claim 31, wherein the metathesis catalyst has a formula: 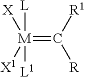
wherein:
M is ruthenium or osmium;
X and X¹ are each independently any anionic ligand;
L and L¹ are each independently any neutral electron donor ligand; and,
R and R¹ are each independently hydrogen or substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl, the substituent optionally substituted with one or moieties selected from the group consisting of C₁-C₁₀ alkyl, C₁-C₁₀ alkoxy, and aryl.

33. The method of claim 32, wherein:
M is ruthenium;
R is hydrogen;
R¹ is selected from the group consisting of C₁-C₁₀ alkyl, C₂-C₁₀ alkenyl, and aryl;
X and X¹ are each independently selected from the group consisting of hydrogen, halide. C₁-C₂₀ alkyl, aryl, C₁-C₂₀ alkoxide, aryloxide, C₃-C₂₀ alkyldiketonate, aryldiketonate, C₁-C₂₀ carboxylate, arylsulfonate, C₁-C₂₀ alkylsulfonate, C₁-C₂₀ alkylthio, C₁-C₂₀ alkylsulfonyl, and C₁-C₂₀ alkylsulfinyl; and
L and L¹ are each independently selected from the group consisting of phosphine, sulfonated phosphine, phosphite, phosphinite, phosphonite, arsine, stibine, ether, amine, amide, imine, sulfoxide, carboxyl, nitrosyl, pyridine, thioether and heterocyclic carbene.

32. The method of claim 33, wherein:
R¹ is selected from the group consisting of phenyl or vinyl, optionally substituted with one or more moieties selected from the group consisting of C₁-C₅alkyl, C₁-C₅ alkoxy, and phenyl;
X and X¹ are each a halide; and
L and L¹ are each independently a phosphine of the formula PR³R⁴R⁵, where R³, R⁴, and R⁵ are each independently aryl or C₁-C₁₀ alkyl.

33. The method of claim 32, wherein:
R¹ substituent is phenyl or —C═C(CH₃)_{2;}
X and X¹ are each chloride and
L and L¹ are selected from a group consisting of -P(cyclohexyl)₃, -P(cyclopentyl)₃, -P(isopropyl)₃, and -P(phenyl)₃.

34. The method of any one of claims 24 to 33, wherein a preformed insert and/or base is placed in the mold prior to use.

35. A cartridge case made by the method of any one of claims 24 to 34.

36. A mold apparatus for making a cartridge case, the mold apparatus comprising:
a mold having a mold chamber for forming a cartridge case; and
an expandable core for insertion into the mold chamber.

37. The mold apparatus of claim 36, wherein the expandable core comprises a mandrel and an expandable bladder.

38. The mold apparatus of claim 37, wherein the mandrel has a top portion and a bottom portion, the bottom portion is coupled to and surrounded by the expandable bladder.

39. The mold apparatus of claim 37 or 38, wherein the expandable bladder is capable of expanding via injection of a fluid into the top portion of the mandrel.

40. The mold apparatus of claim 39, wherein the fluid comprises gas and/or liquid.

41. The mold apparatus of claim 36 or 37, wherein the expandable bladder comprises a plurality of segments and an activator pin.

42. The mold apparatus of claim 41, wherein the plurality of segments slidably shift outwards and engage to form an expanded state when the activator pin is inserted into the top portion of the mandrel.

43. The mold apparatus of any one of claims 36 to 42 for making the cartridge case of any one of claims 1 to 23.

44. Use of the mold apparatus of any one of claims 36 to 42 for making the cartridge case of any one of claims 1 to 23.

45. A cartridge case made by the mold apparatus of any one of claims 36 to 43.

46. The cartridge case of claim 45, wherein the cartridge case is as defined in any one of claims 1 to 23.

47. A system for making a cartridge case, the system comprising the mold apparatus of any one of claims 36 to 43.

48. The system of claim 47, further comprising an injector having a reservoir for injection of a composition into the mold.

49. The system of claim 47 or 48, further comprising a mix head for mixing the composition prior to injection into the mold.

50. The system of any one of claims 47 to 49, wherein the mold is at least one mold and the system further comprises at least one radial runner for conveying the composition to the at least one mold.

51. The system of any one of claims 47 to 50, further comprising a temperature controller for optimizing a temperature for polymerization of the composition within the mold.

52. The system of any one of claims 47 to 51, wherein the mold comprises at least two separate sections combined to form a mold chamber therebetween.

53. A method for making a cartridge case as defined in any one of claims 1 to 23 using the system of any one of claims 47 to 52, the method comprising:
inserting an expandable core into the mold chamber;
injecting the cyclic olefin and a metathesis catalyst simultaneously or consecutively, into the mold chamber;
expanding the bladder before, after or during injecting;
heating the cyclic olefin and a metathesis catalyst to a temperature whereby the cyclic olefin undergoes the ROMP reaction to form the polycycloolefin cartridge case.

54. The method of claim 53, wherein the mold is heated prior to injecting the cyclic olefin and a metathesis catalyst simultaneously or consecutively.

55. The method of claim 53, wherein the mold is heated after injecting the cyclic olefin and a metathesis catalyst simultaneously or consecutively.

56. The method of any one of claims 53 to 55, wherein the bladder is expanded before injecting.

57. The method of any one of claims 53 to 55, wherein the bladder is expanded and the mold is heated before injecting.

58. The method of any one of claims 53 to 57, wherein the bladder is expanded once inserted into the mold chamber.

59. The method of any one of claims 53 to 58, wherein the expandable core is collapsed and the expandable core is removed from the mold chamber after the cartridge case has formed.
